(19) United States
(12) Patent Application Publication
(10) Pub. No.: US 2003/0009539 A1
(43) Pub. Date: Jan. 9, 2003

(54) Distributed object middleware connection method

(75) Inventor: Yasunori Hattori, Fujisawa-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: NTT Software Corporation, Yokohama-shi (JP)

(21) Appl. No.: 10/170,443

(22) Filed: Jun. 14, 2002

(30) Foreign Application Priority Data
Jun. 15, 2001 (JP) 2001-182323

(51) Int. Cl. G06F 15/16

(52) U.S. Cl. 709/219

(57) ABSTRACT

A method for performing a method call from an object in a client to an object in a server when communication protocols of distributed object middlewares in the client and in the server are different is provided. A remote reference obtaining relay object and a class of a remote method calling relay object are provided between the client and the server, and the method includes the steps of: the remote reference obtaining relay object receiving an obtaining request for a remote reference on the object in the server from the client, and sending the obtaining request to the server; the remote reference obtaining relay object receiving, from the server, information used for accessing the object in the server, instantiating the remote method calling relay object corresponding to the object, sending, to the client, information used for accessing the remote method calling relay object.

### BACKGROUND OF THE INVENTION

1. Field of the Invention

The present invention relates to a distributed object middleware connection method. More particularly, the present invention relates to a technology for connecting distributed object middlewares that use different communication protocols.

2. Description of the Related Art

The distributed object technology is a technology which allows distributed program resources (objects) on a network to be used remotely. By using distributed object middleware when distributed objects are used, it becomes possible to call a method of a server object existing in a remote computer by using the same coding as that used when the server object exists locally in a computer. Therefore, efficiency for developing distributed applications that use distributed objects can be improved.

There are two types of communication between distributed objects, which are synchronous communication (example: RPC) and asynchronous communication (example: message exchange). The distributed object middleware previously known as ORB (Object Request Broker) uses synchronous communication. In addition, both asynchronous type and synchronous type communication are used for Web service technologies that have become widespread in recent years, in which communicating messages are written in XML.

In the following, the functions of the distributed object middleware such as ORB will be described in detail.

Examples of the ORB products are Java RMI, Visibroker of Borland, and the like. Java RMI is normally attached to J2ME CLDC (Java2 Platform, Standard Edition, which is a Java execution environment, and Visibroker conforms to CORBA (Common Object Request Broker Architecture) which is a standard developed by OMG (Object Management Group). In addition, BLUEGRID-ORB developed by NTT Software Corporation is an ORB products applicable to J2ME CLDC (Java2 Platform, Micro Edition/Connected Limited Device Configuration) which is a Java execution environment for portable devices such as mobile phones and PDAs. As mentioned above, various ORB products have been developed.

The ORB provides a remote reference obtaining function and a remote method calling function. FIG. 1 shows a processing method of these functions.

The system shown in FIG. 1 includes a client computer 10 and a server computer 20. The client computer 10 includes a client object 11 and a stub object 12. The server computer 20 includes a naming service 21, a skeleton object 22, and a server object 23.

The remote reference obtaining function of ORB provides a function for finding a server object that the client object wants to use, setting up configurations to access the server object 23 and providing information necessary for accessing the client object 11. Generally, the ORB provides the remote reference obtaining function by using the naming service. As shown in FIG. 1, the server object 23 is registered in the naming service 21 beforehand in step 101. The client computer 10 can obtain a remote reference of the server object 23 on the basis of the name of the server object 23, which is registered in steps 102, 103. The client computer 10 obtains information of a stub object to be accessed by obtaining the remote reference. By the remote reference obtaining function, the stub object and the skeleton object are instantiated from class definitions of the stub object and the skeleton object which are prepared beforehand. In the descriptions hereinafter, “an object is generated” or “an object is launched” means that the object is instantiated from a class definition of the object.

The remote reference obtaining function will be further described by using a more specific example. First, in the server computer 20, a server object “Hellow” having a “sayHellow” method and a “calculate” method is registered in the naming service. For example, as for JavaRMI, the object can be registered by using the bind method in the Naming class (step 101). The naming service in the server computer 20 stores the object name “Hellow”, an object ID (10 for example) assigned by the ORB in the server computer 20, method IDs (1 for “sayHellow” method, 2 for “calculate” method, for example) (FIG. 2). Next, the client computer 10 requests the naming service 21 to obtain the remote reference of the server object “Hellow”. For example, as for JavaRMI, the request can be performed by using the lookup method in the Naming class (step 102). The client computer 10 sends information such as the sever object name “Hellow” necessary for obtaining the remote reference (FIG. 3).

It is assumed that the client computer 10 stores the host name (“XXX” for example) of the server computer 20 and a port number (100 for example) beforehand. The server computer 20 obtains, by using the name received from the client computer 10, the object ID and the method IDs that are associated with the name, and the server computer 20 sends the obtained object ID and the method IDs to the client computer 10. The ORB of the client computer 10 stores the object ID and the method IDs associated with the name of the server object as a preparation for remote method calling by the client object (step 103).

Next, the remote method calling function will be described. The remote method calling function provides a function to return, to the client object 11, a return value from a method of the server object 23 called by the client object 11.

A pair of a stub object and a skeleton object is generated by obtaining remote reference, so that communication between the client object 11 and the server object 23 are performed via the stub object 12 in the client computer 10 and the skeleton object 22 in the server computer 20.

In the following, internal processes of the remote method calling function in a general ORB product will be described with reference to FIG. 1

When the client object 11 calls a method of the stub object 12, which is obtained by obtaining the remote reference in step 104, the stub object 12 sends serialized data of arguments, an object ID, and a method ID to the skeleton object 22 in step 105. The skeleton object 22 identifies an actual object from the received object ID, and calls the method corresponding to the method ID in the object. When calling the method, the skeleton object 22 deserializes the serialized argument data and passes the data to the target object in step 106. Next, the skeleton object 22 serializes the return value data obtained by method calling in step 107, and returns the serialized data to the stub object 12 in step 108. The stub object deserializes the received return value data, and returns it to the client object in step 109.

As mentioned above, the program of the client computer accesses the remote object 23 via the stub object 12 and the skeleton object 22.

As for Java RMI, as shown in FIG. 4, class definitions of the stub object 12 and the skeleton object 22 can be automatically generated from the target server class by a tool provided by RMI, and placed between the client computer 10 and the server computer 20. Since complicated communication processes are hidden by the stub/skeleton which are automatically generated by a tool, an application developer can develop a distributed object application efficiently.

In the remote reference obtaining function and the remote method calling function, the communication protocol for using the naming service, the communication protocol between stub and skeleton, arguments of the method, and the type of return value from the method are different according to communication protocols (JRMP, IIOP, SOAP and the like) to be implemented in the ORB product. The present invention relates to a connection technique between ORB products that implement such different communication protocols.

When an object of a server application based on a communication protocol and an ORB product is used from an object in a client program operated on the basis of a new communication protocol, difference of formats of send/receive data, assigning methods of an object ID and a method ID, serialized formats for method calling argument and return value can be handled by porting the same ORB product as is used in the target server to the client computer, or by providing a protocol converting mechanism between the client computer and the server computer.

However, when an executing environment of a client program (object) is newly developed such that the executing environment becomes adaptable to hardware conditions of the client, the ORB product implemented on the server having the target object is not necessarily soon ported to the client. In addition, in a client program executing environment in which hardware resources are limited such as in a mobile device, there is a case in which the ORB product can not be ported due to limitation of memory size and the like. In such a case, the client uses an ORB product different from that used in the server.

As mentioned above, when the ORB product used in the client and that used in the server are different, the communication protocols are different, so that the remote reference obtaining function in the client can not use the naming service in the server. In addition, the stub object located in the client can not communicate directly with the skeleton object located in the server.

To solve such problem, there is a method for using a gateway program for performing interconversion between the communication protocols used in the client computer and the server computer as shown in FIG. 5. Communication between different ORB products becomes possible by using this method. However, the gateway program needs to be developed for each combination of ORBs in the client and the server for realizing this method. Thus, this method spoils one of the merits of ORB that software can be easily developed by using the remote object.

As another conventional technique, Japanese laid-open patent applications No. 11-282661 and No. 2000-99476 disclose a system in which a relay program is provided in a Firewall for relaying communication between a client and a server wherein the client and the server can not communicate with each other directly due to the Firewall. By using the relay program which is automatically generated from a class definition in a server and placed in the Firewall, remote method call by a client object becomes available.

However, the Japanese laid-open patent applications do not disclose a method for solving the differences, between client and server, of the communication protocols, arguments of method, and types of return values, so that the above-mentioned problems can not be solved. In addition, according to the system in the Japanese laid-open patent applications, there is a problem in that memory space in the firewall computer is uselessly consumed since the relay program is always activated.

### SUMMARY OF THE INVENTION

An object of the present invention is to provide a method for allowing connection between distributed object middlewares in the client and the server even when the distributed object middlewares are different, so that the client can easily use a remote object in the server.

The above object can be achieved by a method for performing a method call from an object in a client to an object in a server when a communication protocol of a distributed object middleware in the client and a communication protocol of a distributed object middleware in the server are different, wherein a class of a remote reference obtaining relay object and a class of a remote method calling relay object are provided between the distributed object middleware in the client and the distributed object middleware in the server, the method comprising the steps of:

the remote reference obtaining relay object receiving an obtaining request for a remote reference on the object in the server from the client, and sending the obtaining request to the server;

the remote reference obtaining relay object receiving, from the server, information used for accessing the object in the server, and instantiating the remote method calling relay object corresponding to the object;

the remote reference obtaining relay object sending, to the client, information used for accessing the remote method calling relay object.

The method may further include the step of:

the remote method calling relay object receiving from the client a remote method call corresponding to a method in the object in the server, and calling the method in the object in the server.

According to the present invention, a remote reference obtaining relay object and a remote method calling relay object are provided between an ORB in the client and an ORB in the server. The remote method calling relay object is necessary for each server object, and, the class definition for the remote method calling relay object can be automatically generated from the class definition of the server object. In addition, only one remote reference obtaining relay object is necessary, that is, it is not necessary for each server object. Therefore, the load of developing programs for connecting the middlewares can be eliminated.

Since the remote reference obtaining relay object automatically instantiates the remote method calling relay object when the remote reference obtaining relay object obtains the remote reference of the server object in response to a request from the client, it is not necessary for the remote method calling relay function to be activated at all times.

That is, according to the present invention, interoperability between ORBs having different communication protocols can be easily ensured, so that it becomes possible to efficiently develop distributed applications in which objects existing in various program executing environments communicate with each other.

In addition, according to the computer readable medium of the present invention, by storing the class in a relay computer, instantiating the class, and by storing other files in the relay computer as necessary, the distributed object connection of the present invention can be realized.

### BRIEF DESCRIPTION OF THE DRAWINGS

Other objects, features and advantages of the present invention will become more apparent from the following detailed description when read in conjunction with the accompanying drawings, in which:

FIG. 1 shows a process method of a general distributed object middleware;

FIG. 2 shows an example of registered information in a naming service in a server computer;

FIG. 3 shows an example of sending information for requesting remote reference;

FIG. 4 shows a generation process for a stub class and a skeleton class in distributed object middleware;

FIG. 5 shows a protocol conversion method using a gateway program generally used for connecting different distributed object middlewares;

FIG. 6 is a figure for explaining a connection system for different distributed object middleware products according to an embodiment of the present invention;

FIG. 7 is a flow chart showing an operation of a remote reference obtaining relay object according to an embodiment of the present invention;

FIG. 8 is a flow chart showing an operation of a remote method calling relay object according to an embodiment of the present invention;

FIG. 9 shows a flow chart of a generation process of the remote method calling relay class by using a remote method calling relay class generation tool according to an embodiment of the present invention;

FIG. 10 shows a flow chart of a process for generating classes relating to the remote reference obtaining relay class according to an embodiment of the present invention;

FIG. 11 shows a flow chart of a generation process of classes relating to the remote method calling relay class according to an embodiment of the present invention;

FIG. 12 shows a process for adding an object C to the server computer;

FIG. 13 shows stored class files;

FIG. 14 shows that server objects are instantiated and are registered in the naming service in the server;

FIG. 15 shows that the remote reference obtaining relay object is instantiated and is registered in the naming service of the relay computer;

FIG. 16 shows that the client object obtains the remote reference of the remote reference obtaining relay object from the naming service of the relay computer;

FIG. 17 shows that the remote reference obtaining relay object in the relay computer obtains the remote reference of the server object from the naming service;

FIG. 18 shows that the remote reference obtaining relay object in the relay computer instantiates the remote method calling relay object;

FIG. 19 shows that the remote reference obtaining relay object returns the remote reference of the instantiated remote method calling relay object to the client object;

FIG. 20 shows that the client computer calls a method in the server object B by using the remote method calling relay object;

FIG. 21A shows an interface definition example: INamingBridge.java of the remote reference obtaining relay object;

FIG. 21B shows a class definition example: NamingBridge.java of the remote reference obtaining relay object;

FIG. 22A shows an interface definition example IHello.java of the server object;

FIG. 22B shows a class definition example: Hello.java of the server object:

FIG. 23A shows an output example of an interface: IHelloBridge.java of the remote method calling relay object;

FIG. 23B shows a class output example: HelloBridge.java of the remote method calling relay object;

FIG. 24 shows a class definition example: Client.java of the client.

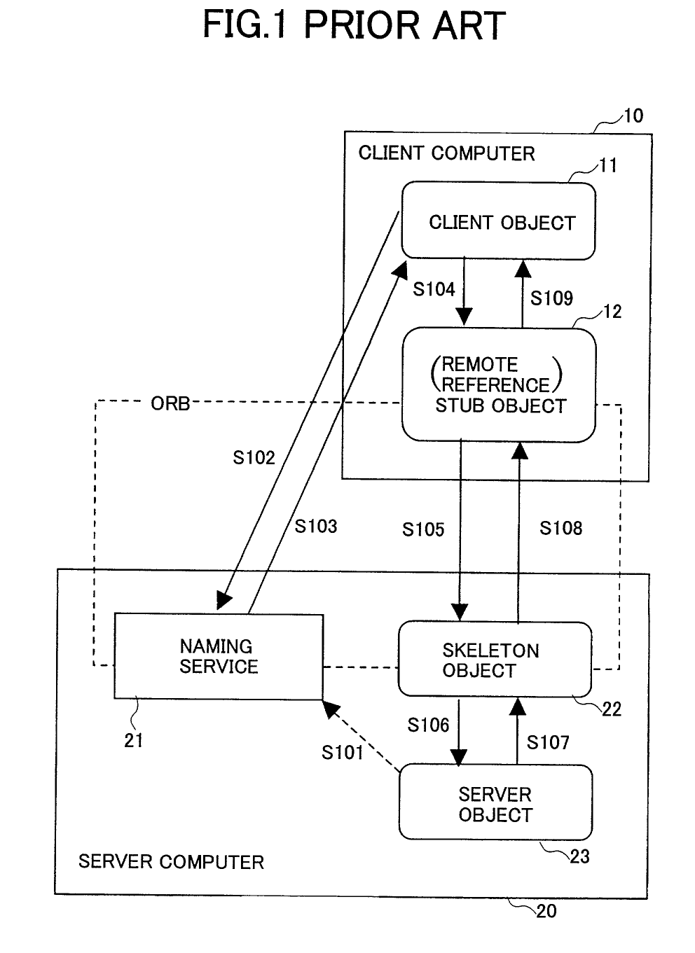

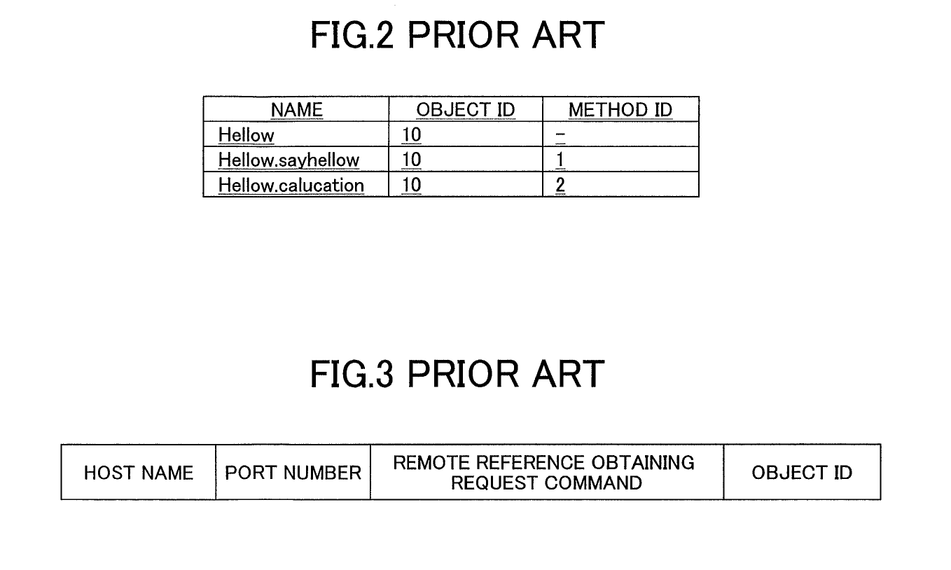

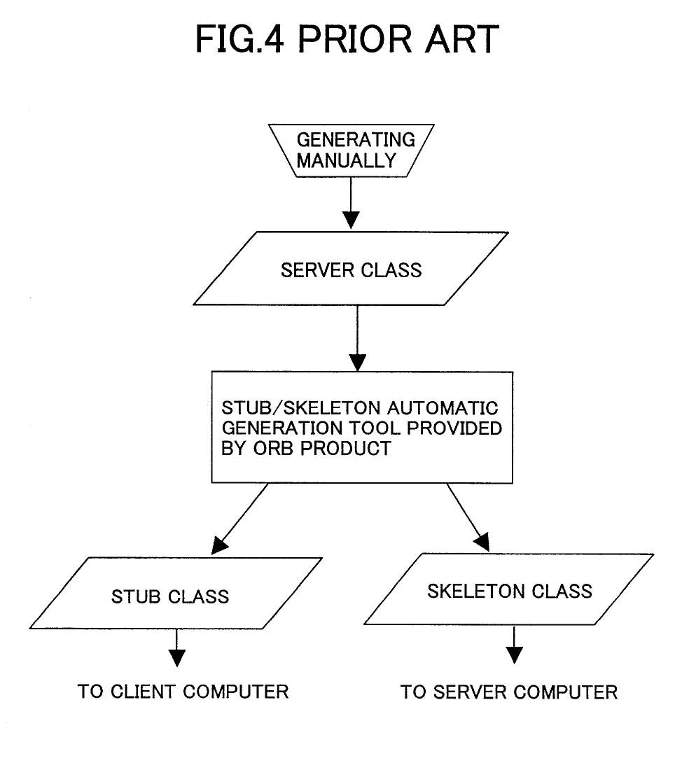

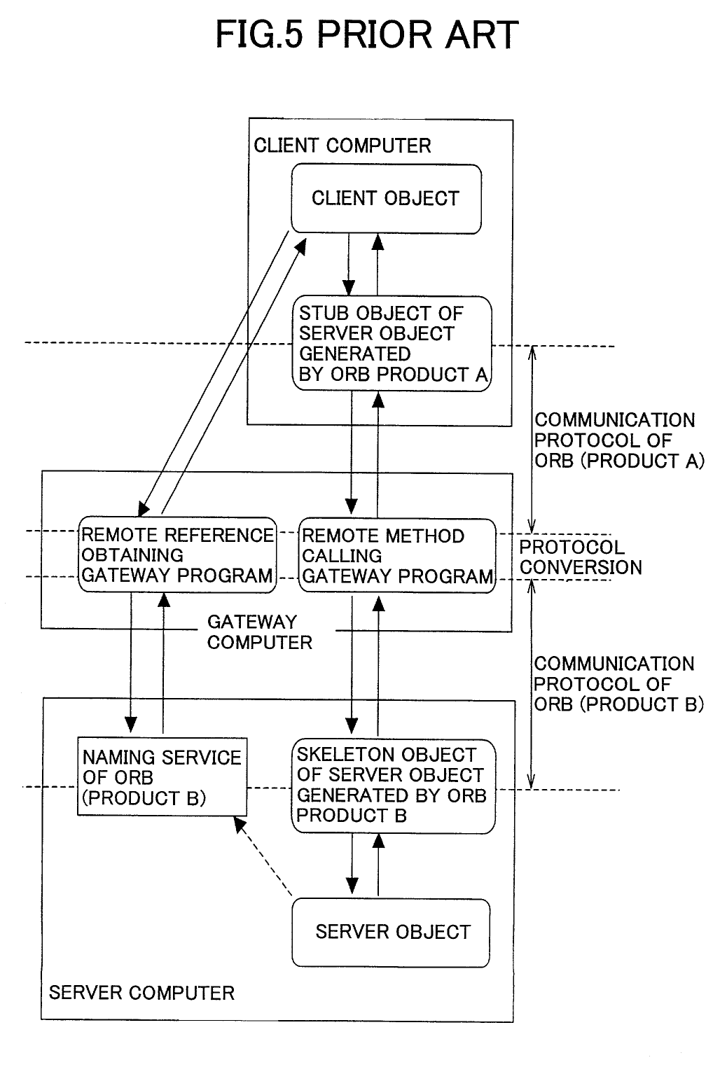

### DETAILED DESCRIPTION OF THE PREFERRED EMBODIMENTS

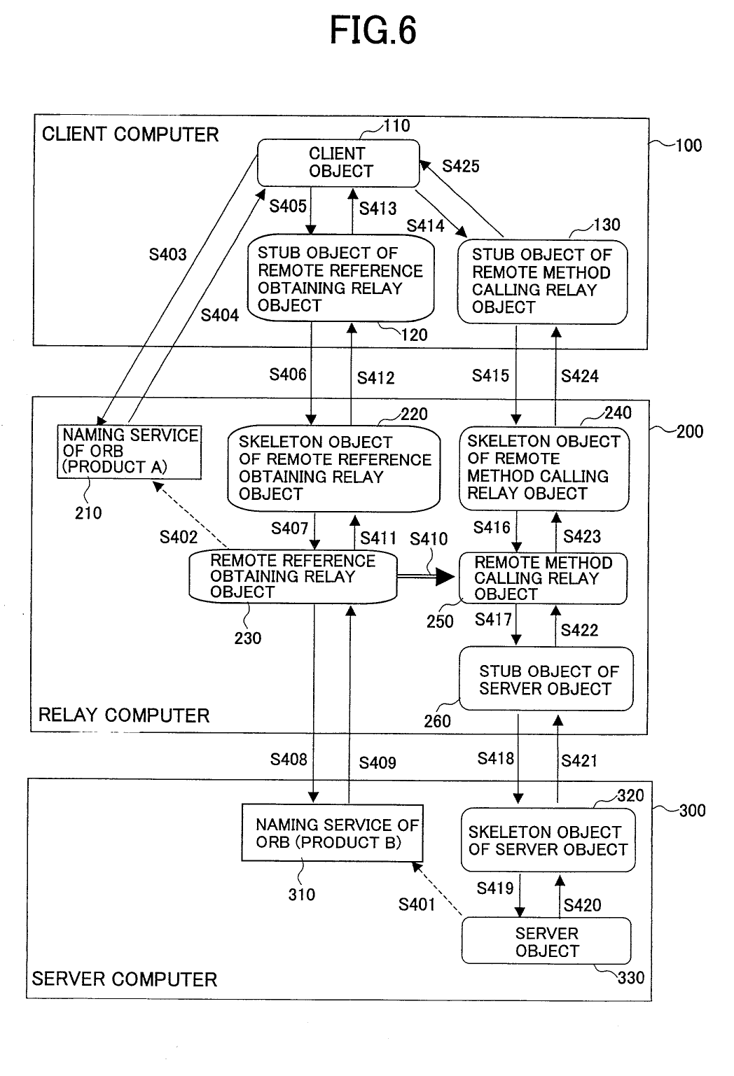

FIG. 6 is a figure for explaining a connection system for different distributed object middlewares according to an embodiment of the present invention.

The distributed object middleware connection system shown in the figure includes a client computer 100, a relay computer 200 and a server computer 300.

In a state shown in FIG. 6, the client computer 100 includes a stub object 120, generated by an ORB (product A) tool, of a remote reference obtaining relay object, and a stub object 130, generated by an ORB (product A) tool, of a remote method calling relay object.

The relay computer 200 includes a naming service 210 of the ORB (product A), a skeleton object 220, generated by an ORB (product A) tool, of the remote reference obtaining relay object, the remote reference obtaining relay object 230, a skeleton object 240, generated by an ORB (product A) tool, of the remote method calling relay object, the remote method calling relay object 250, and a stub object 260, generated by an ORB (product B) tool, of a server object.

Since the stub object 130 and the skeleton object 240 of the remote method calling relay object 250 are generated by the ORB (product A) tool, the stub object 130 and the skeleton object 240 operate according to a communication protocol of the ORB (product A).

The server computer 300 includes a naming service 310 of the ORB (product B), a skeleton object 320, generated by an ORB (product B) tool, of the server object, and a server object 330.

Since the stub object 260 and the skeleton object 320 of the server object 330 are generated by the ORB (product B) tool, the stub object 260 and the skeleton object 320 operate according to a communication protocol of the ORB (product B).

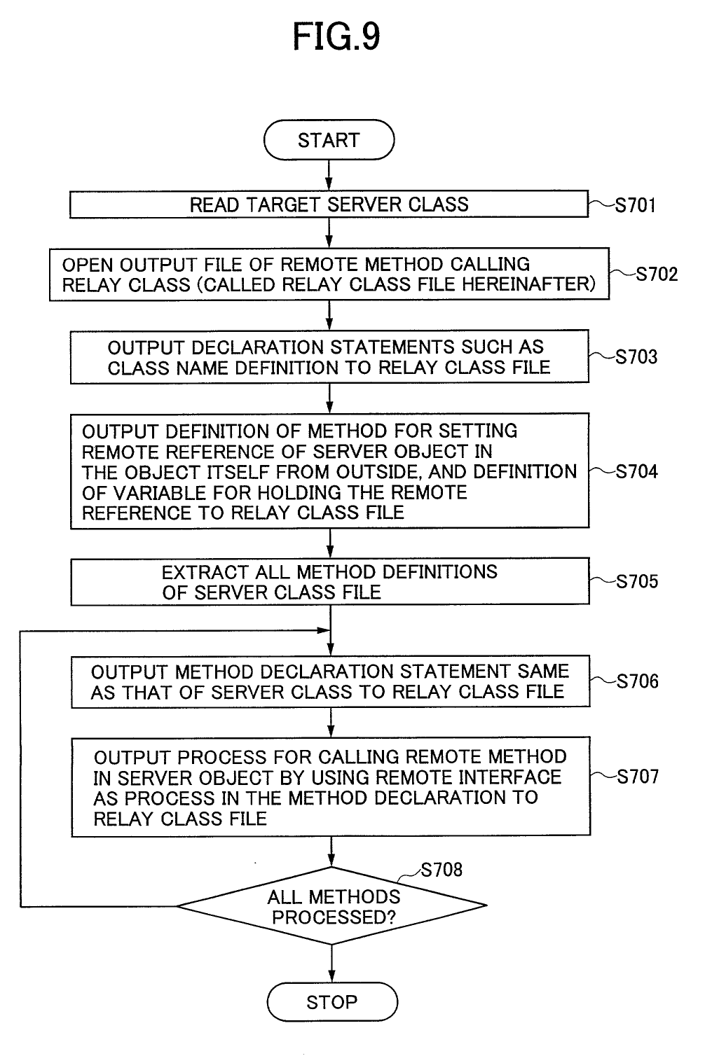

Each above-mentioned object is generated (instantiated) from a class stored in the computer beforehand. Generation methods of classes and the like will be described with reference to figures starting from FIG. 9.

In the following, an example will be described in which the client computer 100, which uses the ORB (product A), connects to the server computer 300, which uses the ORB (product B), via the relay computer 200.

In the relay computer 200, the remote reference obtaining relay object 230 receives a remote reference obtaining request for the target server object 330 from the client object 110 by the ORB (product A) protocol, and sends the request to the naming service 310 in the server computer 300 by the ORB (product B) protocol.

In addition, in the relay computer 200, the remote method calling relay object 250 receives a remote method call for the server object 330 from the client object 110 by the ORB (product A) protocol, and calls the remote method in the server object by the ORB (product B) protocol.

In the following the processes will be described in more detail

First, as a preparation, like a conventional system, a server object 330 is registered in the naming service 310 of the ORB (product B) in the server computer 300 by using an arbitrary name in step 401 such that another computer can access the server object 330. In addition, a remote reference obtaining relay object 230 is registered by using an arbitrary name in the naming service 210 of the ORB (product A) in the relay computer 200 in step 402 such that the client computer 100 can access the remote reference obtaining relay object 230.

The client object 110 launched in the client computer 100 connects to the naming service 210 in the relay computer 200 and requests a remote reference of the remote reference obtaining relay object 230 in step 403. The naming service 210 in the relay computer 200 provides the remote reference of the remote reference obtaining relay object 230 to the client object 110 in step 404. When the remote reference is provided to the client object 110, the skeleton object 220 and the stub object 120 corresponding to the remote reference obtaining relay object 230 are generated in the relay computer 200 and in the client computer 100 respectively. The remote reference provided to the client object 110 is information used for accessing the stub object 120.

The remote reference obtaining relay object 230 receives a connection request from the client object 110 to the server computer 300, finds the server object 330 from the naming service of the ORB (product B), and gets a remote reference for the server object 330. Next, such processes will be described in detail.

The client object 110 calls the remote reference obtaining method in the stub object 120, and requests connection to the server object 330 by using the registered name of the server object 330 in step 405.

The request is sent to the skeleton object 220 in the relay computer 200 by network communication processes based on notification protocol implemented in the ORB (product A) between stub/skeleton (the stub object 120 of the client computer 100 and the skeleton object 220 of the relay computer 200) in step 406. Then, the skeleton object 220 calls the remote reference obtaining method in the remote reference obtaining relay object 230 in step 407. Then, the remote reference obtaining relay object 230 requests the remote reference of the server object 330 corresponding to the registered name from the naming service 310 of the server computer 300 in step 408.

The naming service 310 in the server computer 300 returns the remote reference of the corresponding server object 330 in step 409. At this time, like in the step 404, the skeleton object 320 and the stub object 260 corresponding to the server object 330 are generated in the server computer 300 and in the relay computer 200 respectively by the ORB (product B). The remote reference provided to the remote reference obtaining relay object 230 is information used for accessing the stub object 260 of the target server object 330.

The remote reference obtaining relay object 230 in the relay computer 200, which receives the remote reference for the server object 330 which is requested by the client object 110, checks the type of the remote reference, instantiates corresponding remote method calling relay object 250 in step 410. In addition, the skeleton object 240 corresponding to the remote method calling relay object 250 is launched by the ORB (product A), and the result is sent to the stub object 120 in the client computer 100 via the skeleton object 220 by the communication protocol of the ORB (product A) in steps 411 and 412. Then, the stub object 130 is launched in the client computer 100. Finally, access information to the stub object 130 is returned to the client object 110 as the remote reference of the server object 330.

The client object 110 can freely call a method of the server object 330 by using the remote reference of the remote method calling relay object 250. The remote method calling relay object 250 generated in the step 410 relays a method call from the client object in the ORB (product A) and a method call to the server object 330 in the ORB (product B). In the following, such processes will be described in detail.

The client object 110 in the client computer 100 calls a method which is in the stub object 130 of the remote method calling relay object 250 and which is corresponding to the method to be called in the server object 330 in step 414.

When the method in the stub object 130 is called by the client object 110, information of the call is sent to the skeleton object 240 in the relay computer 200 by a network communication processing between stub/skeleton (the stub object 130 and the skeleton object 240) in step 415, and the skeleton object 240 calls the corresponding method of the remote method calling relay object 250 in step 416. The remote method calling relay object 250 calls a method which is in the stub object 260 of the server object 330 and has the same name as that of the method called from the skeleton object 240 in step 417. Information for this call is sent to the skeleton object 320 in the server computer 300 by a network communication processing between stub/skeleton (stub object 260 and the skeleton object 320) in step 418, and the skeleton object 320 calls the actual method in the server object 330 in step 419.

A return value from the method of the server object 330 (step 420) is sent to the stub object 260 in the relay computer 200 by network communication between the skeleton object 320 and the stub object 260 in step 421, and is returned to the remote method calling relay object 250 in step 422.

The remote method calling relay object 250 which receives the return value returns the return value to the skeleton object 240 in step 423. The value is sent to the stub object 130 in the client computer 100 by a network communication processing between the skeleton object 240 and the stub object 130 in step 424. In step 425, the stub object 130 returns, to the client object 110, the return value received from the skeleton object 240 in step 424.

As mentioned above, by providing the relay computer 200 between the ORB (product A) in the client computer 100 and the ORB (product B) in the server computer 300, and providing the remote reference obtaining relay object 230 and the remote method calling relay object 250, it becomes possible to connect the client object 110 and the server object 330 without complicated protocol conversion processes.

Next, the operation of the remote reference obtaining relay object 230 will be described in detail.

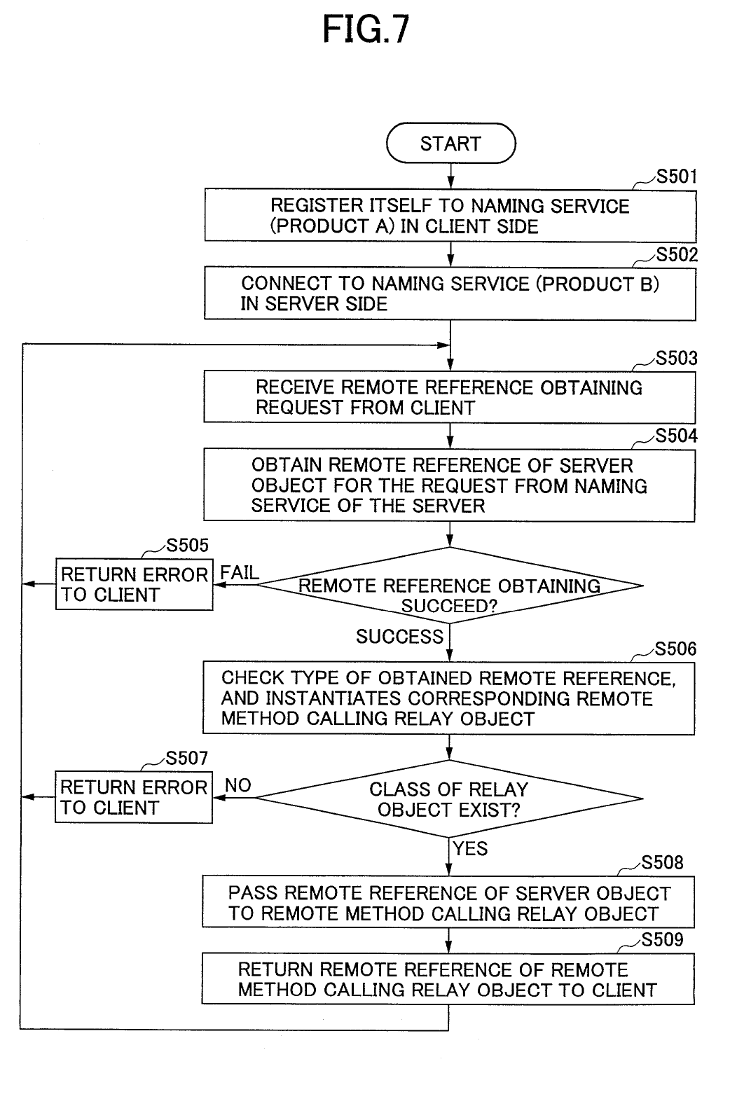

FIG. 7 is a flow chart showing the operation of the remote reference obtaining relay object 230 according to an embodiment of the present invention.

When the remote reference obtaining relay object 230 is launched, the remote reference obtaining relay object 230 itself is registered to the naming service (product A), so that it can be accessed by the client computer 100 in step 501.

Next, the remote reference obtaining relay object 230 connects to the naming service (product B) 310 such that it can obtain a remote reference of the server object 330 in step 502, and waits for connection by the client object 110. When the remote reference obtaining relay object 230 is accessed by the client computer 100 and the remote reference obtaining method is called in step 503, the remote reference obtaining relay object 230 obtains the remote reference of the server object 330 from the naming service 310 of the server computer 300 by using the server object registration name which is received as a method argument in step 504.

If the server object 330 is not registered in the naming service 310 so that the remote reference can not be obtained, an error is returned to the client object 110 in step 505. When the remote reference of the server object 330 is successfully obtained, the type is checked, and the corresponding remote method calling relay object 250 is launched (instantiated) in step 506.

If the class definition of the corresponding remote method calling relay object does not exist, an error is returned to the client object 110 in step 507.

When the remote method calling relay object 250 is launched, the remote reference of the server object 330 obtained from the naming service is set to the object 250 in step 508.

Finally, the stub object 130 and the skeleton object 240 corresponding to the remote method calling relay object 250 are instantiated, and a remote reference of the remote method calling relay object 250 (access information to the corresponding stub object 130) is returned to the client computer in step 509 and waits for a next remote reference obtaining request. As mentioned above, when the client object 110 obtains the remote reference for the target server object 330, a set of the remote method calling relay object 250, the stub object 130, the skeleton object 240, the stub object 260 and the skeleton object 320 is generated for accessing methods of the target server object 330.

Next, the operation of the remote method calling relay object 250 will be described in detail.

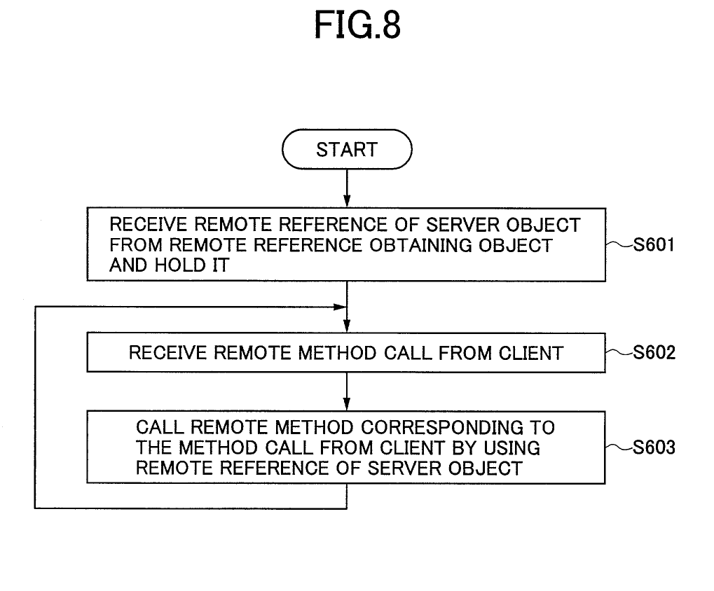

FIG. 8 is a flow chart showing the operation of the remote method calling relay object 250 according to an embodiment of the present invention.

The remote method calling relay object 250 is prepared beforehand as a class file corresponding to a server object used from the client, and is launched by the remote reference obtaining relay object 230 each time when the request for obtaining the remote reference of the corresponding server object is sent from the client object 110. When the remote method calling relay object 250 is launched, the remote method calling relay object 250 receives the remote reference (access information for accessing the corresponding stub object 260) from the remote reference obtaining relay object 230, and holds it as an internal variable in step 601, and waits for remote method calling from the client object 110. When the remote method is called from the client computer 100 (when the method of the remote method calling relay object 250 is called via the corresponding stub object 130 and the skeleton object 240) in step 602, the remote method calling relay object 250 calls the corresponding method by using the held remote reference of the server object 330 (the method of the server object 330 is called via the corresponding stub object 260 and the skeleton object 320) in step 603, and a return value of the called method of the server object 330 is returned to the client object 110 in the reverse direction.

Next, a generation process of the remote method calling relay class by using a remote method calling relay class automatic generation tool will be described.

The remote method calling relay object is generated from a prepared remote method calling relay class. FIG. 9 shows a generation process of the remote method calling relay class. This process can be automatically generated by using a tool.

The remote method calling relay class is automatically generated from a class definition of a target server object. First, all of the definition of the target server object class is read in step 701.

Next, an output file of the remote method calling relay class (which will be called as “relay class file” hereinafter) is opened in step 702, and a typical definition such as a class name declaration statement is output to the relay class file. At this time, an interface necessary for identifying the server object of the ORB to be used is also installed in step 703.

The remote reference obtaining relay object 230 obtains the remote reference of the server object 330, and passes information for accessing the server object 330 to the remote method calling relay object 250 when the remote method calling relay object 250 is instantiated. Thus, a method definition for receiving the information for accessing the server object 330 from the remote reference obtaining relay object 230, and a definition of a variable for holding the information are output to the relay class file in step 704.

Next, every method defined in the server class is extracted in step 705. The same method declaration as that of the server method is output to the relay class file. At this time, if the type of the argument and return value of the method is a type which can not be used in the client environment, the type is converted into a type which can be used in the client environment and which is interchangeable with the original type in step 706. As a process of the method, processes for calling the same method as that in the server object 330 by using the received remote reference of the server object 330 are output. When the type is to be changed in step 706, a type converting process for argument is included before the process for calling the server object, and/or type converting process for return value is included after the process for calling the server object. When the type to be converted is a user definition class, the conversion process of user definition is incorporated and converted in step 707. The above process is repeated for each method defined in the server class in step 708.

Next, a generation process for classes relating to the remote reference obtaining relay class will be described.

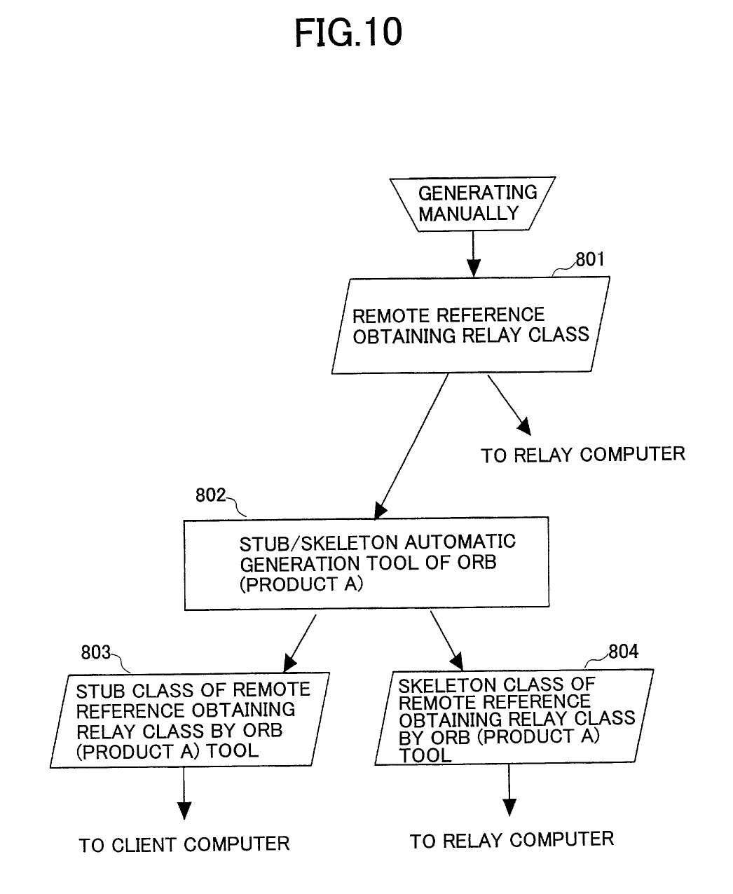

FIG. 10 shows a process for generating classes relating to the remote reference obtaining relay class according to an embodiment of the present invention.

The remote reference obtaining relay class implements the processes shown in the flow chart shown in FIG. 7 as an object of the ORB (product A).

The remote reference obtaining relay class 801 is stored in the relay computer 200. The stub class 803 and the skeleton class 804 are generated by inputting the remote reference obtaining relay class into a stub/skeleton automatic generation tool 802 of the ORB (product A). The stub class of the remote reference obtaining relay class is stored in the client computer 100 and the skeleton class is stored in the relay computer 200.

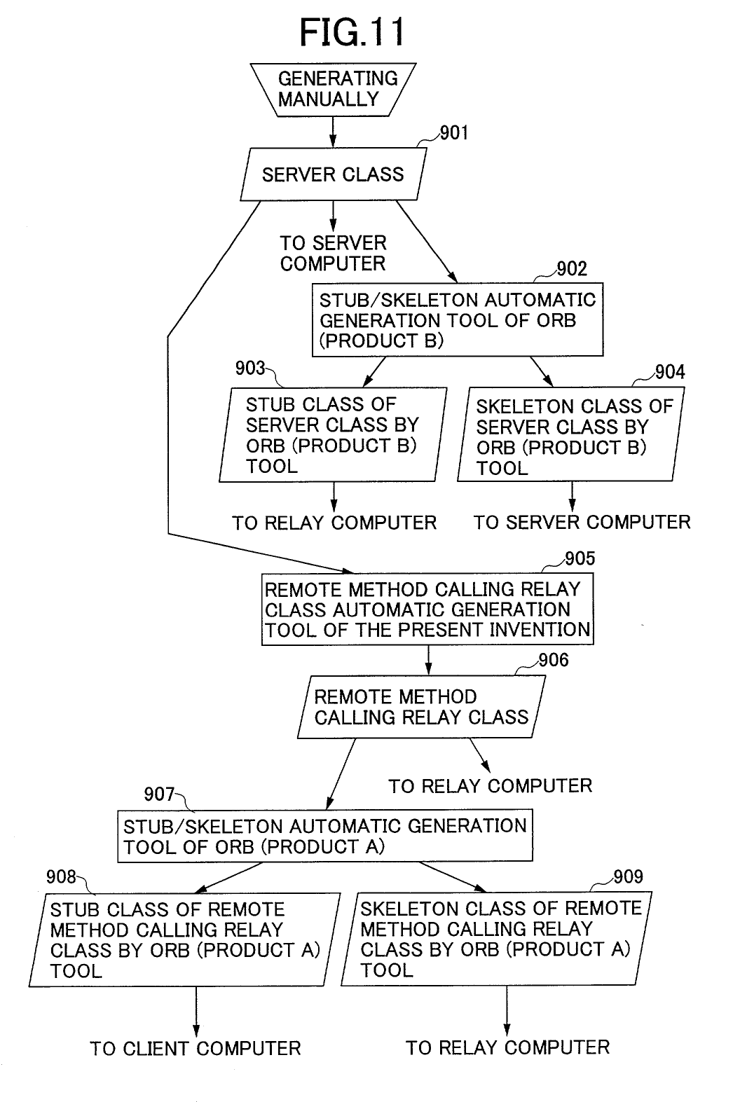

Next, a generation process of the classes relating to the remote method calling relay class will be described with reference to FIG. 11.

The server class 901 is implemented as a format that operates as the server object of the ORB (product B). The server class 901 is stored in the server computer 300. The stub class 903 and the skeleton class 904 are generated by inputting the server class into a stub/skeleton automatic generation tool 902 of the ORB (product B). The stub class 903 of the server class 901 is stored in the relay computer 200, and the skeleton class 904 is stored in the server computer 300. The server class 901 is input into the remote method calling relay class automatic generation tool 905, so that the remote method calling relay class 906 is generated according to the processes shown in FIG. 9. The class 906 is stored in the relay computer 200. Finally, the generated remote method calling relay class is input into a stub/skeleton automatic generation tool 907 of the ORB (product A), so that the stub class 908 and the skeleton class 909 are generated. The stub class 908 of the remote method calling relay class is stored in the client computer 100 and the skeleton class 909 is stored in the relay computer 200.

### EXAMPLE

Next, as an example using the distributed object middleware connection method of the present invention, processes of (1) adding, to the server, an object to be accessed by a client object, (2) setting up configuration in the server computer and the relay computer, (3) launching stub/skeleton are described in detail.

(1) Adding an object to be accessed by a client object.

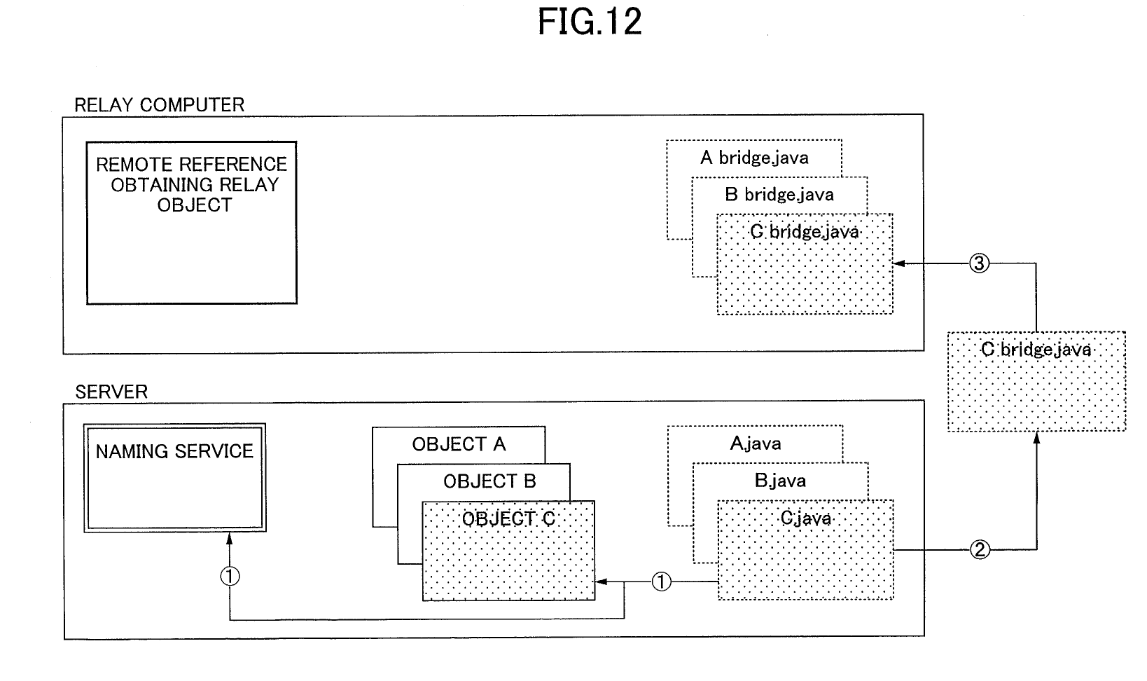

The process for adding an object C to the server computer will be described with reference to FIG. 12.

(Step 1) A class file (class file name “C.java” in the figure) of the server object C to be added is placed in the server, and the object C is instantiated and the object C is registered in the naming service.

(Step 2) A class file (class file name “CBridge.java”) of the remote method calling relay object is generated by using the automatic generation tool on the basis of the class file “C.java” of the server object to be added. In the example shown in FIG. 12, the class file name of the remote method calling relay object is represented by adding “Bridge” after the class file name of the server object.

(Step 3) The remote method calling relay class file is placed on the relay computer. It is noted that the remote reference obtaining relay object is not changed when the server object is added.

(2) Setting up configurations in the sever and the relay computer before the client uses them

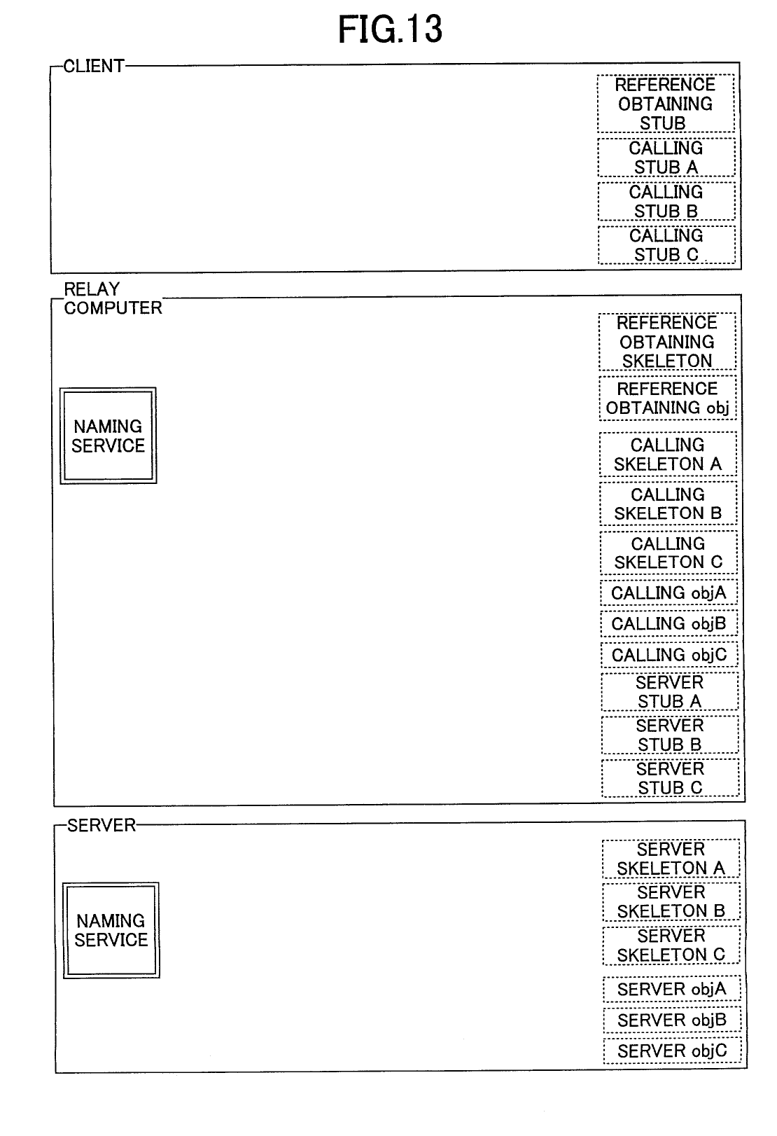

Next, configuration set up in the sever and the relay computer for making the remote object usable by the client will be described with reference to FIGS. 13-15.

The configuration set up can be performed in an order of storing class files (step 1), launching the server object and registering it to the naming service (step 2), and launching the remote reference obtaining relay object and registering it to the naming service (step 3). In the following, the steps will be described in this order.

(Step 1) Storing class files

First, as shown in FIG. 13, the class files are stored to a corresponding computer.

Files stored in the server are: class files of each server object (server obj A, B, C), class files of skeletons corresponding to server objects (server skeleton A, B, C).

Files stored in the relay computer are: class files of stubs corresponding to the server objects (server stub A, B, C), class files of remote method calling relay objects (calling obj A, B, C), class files of skeletons corresponding to remote method calling relay objects (calling obj A, B, C), class file of the remote reference obtaining relay object (reference obtaining obj), object of skeleton corresponding to the remote reference obtaining relay object (reference obtaining skeleton).

Files stored in the client are: class files of stubs corresponding to remote method calling relay objects (calling stub A, B, C), an object of the stub of the remote reference obtaining relay object (reference obtaining stub).

(Step 2) Launching server object and registering it to the naming service

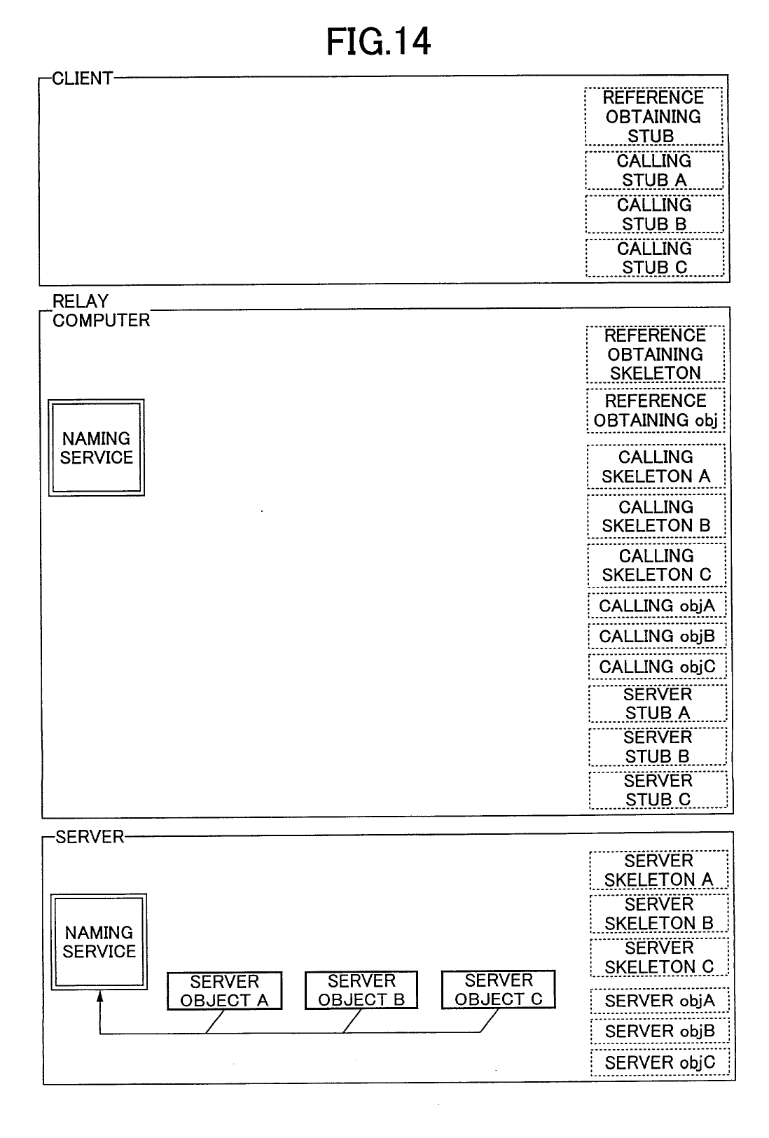

Next, as shown in FIG. 14, the server objects are instantiated and are registered in the naming service in the server.

(step 3) Launching the remote reference obtaining relay object and registering it to the naming service

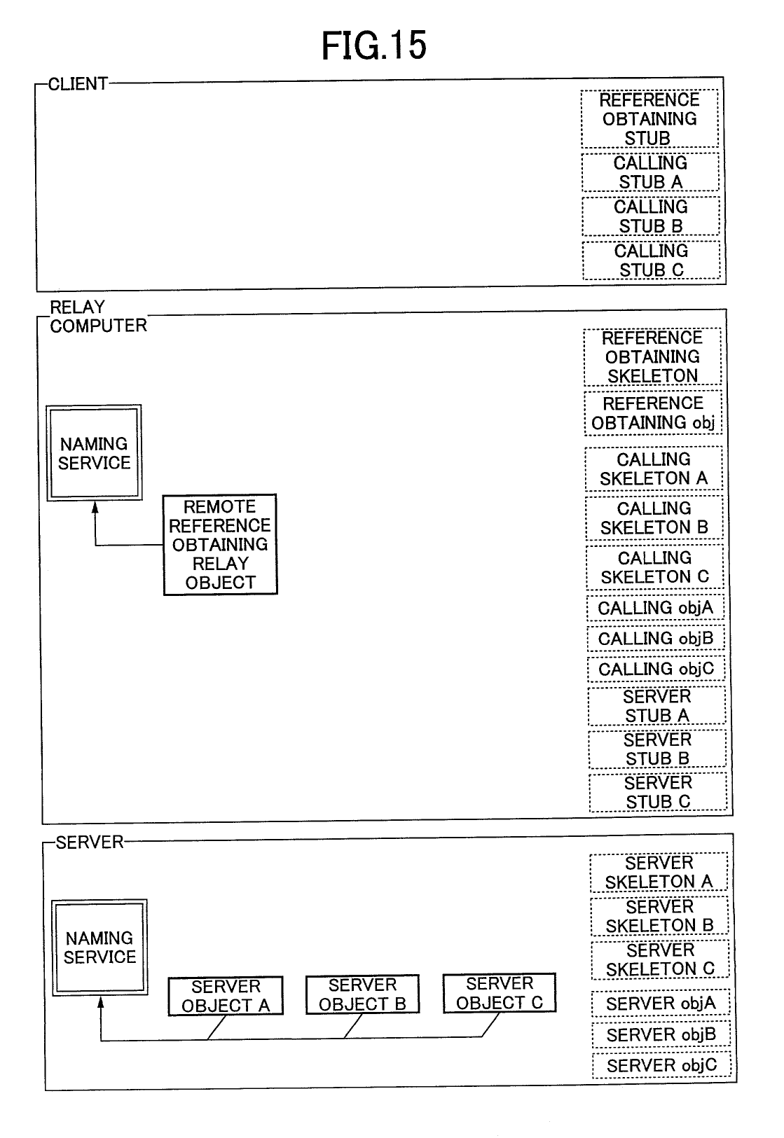

Next, as shown in FIG. 15, the remote reference obtaining relay object is instantiated and is registered in the naming service of the relay computer.

(3) Launching stub/skeleton object when the client accesses the server object

This process is performed in an order of obtaining a remote reference of the remote reference obtaining relay object (step 1), obtaining a remote reference of the server object (step 2), launching the remote method calling relay object (step 3), returning a remote reference of the remote method calling relay object (step 4), and method calling of the server object (step 5).

(Step 1) Obtaining remote reference of the remote reference obtaining relay object

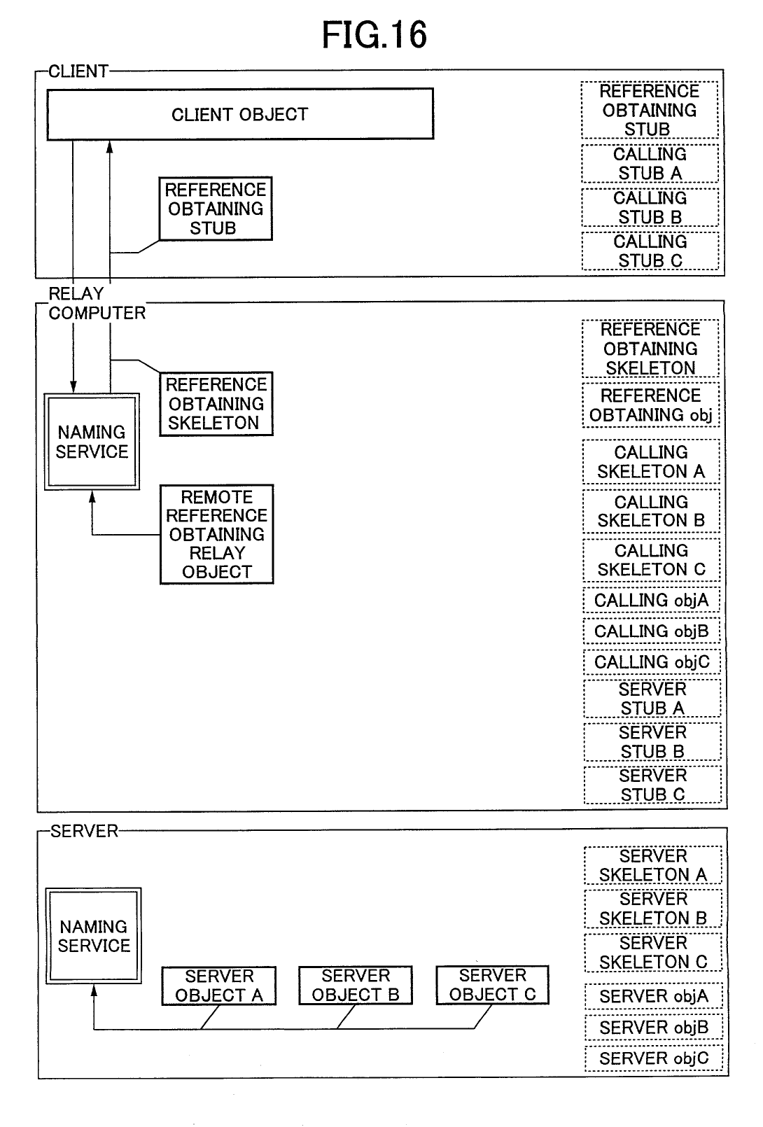

As shown in FIG. 16, the client object obtains the remote reference of the remote reference obtaining relay object from the naming service of the relay computer. When obtaining the remote reference, the skeleton of the remote reference obtaining relay object is instantiated by ORB in the relay computer, and the stub of the remote reference obtaining relay object is instantiated by ORB in the client.

As a result of obtaining the remote reference, information for accessing the stub object that is instantiated is returned to the client object.

(Step 2) Obtaining remote reference of the server object

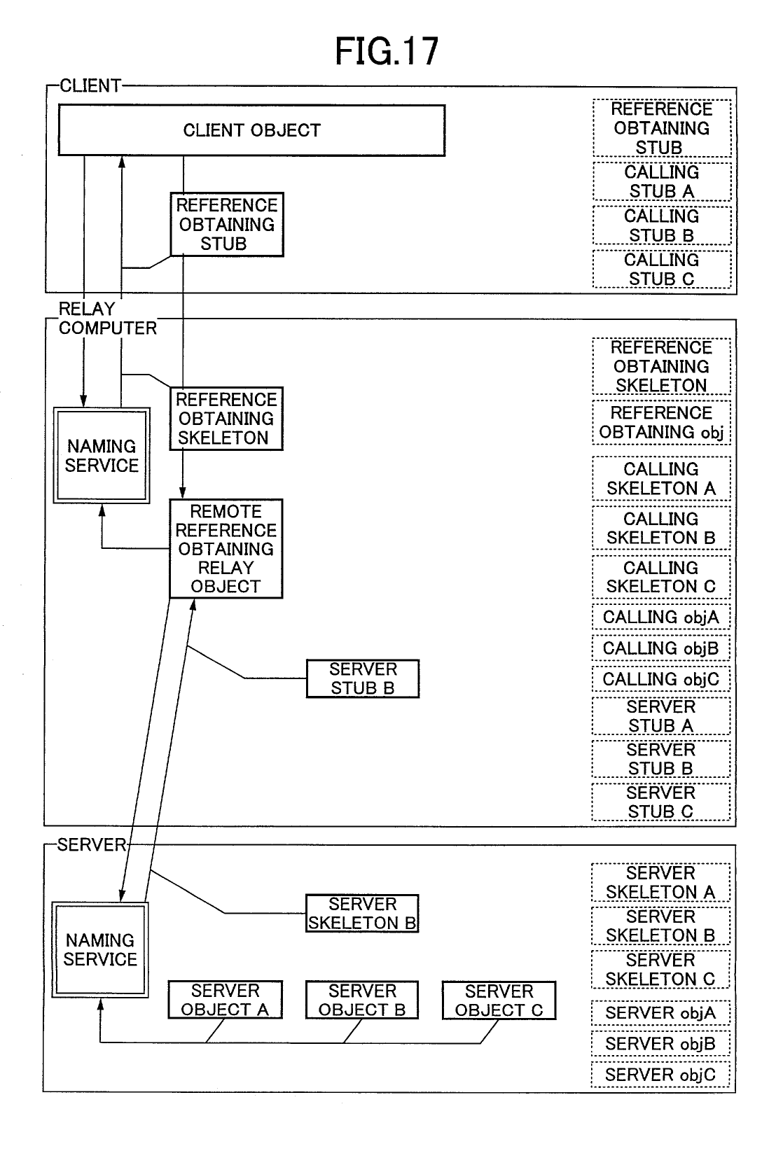

Next, as shown in FIG. 17, the remote reference obtaining relay object in the relay computer obtains the remote reference of the server object from the naming service (FIG. 17 shows a case when a server object B is indicated) in response to a request from the client object via the sub/skeleton objects. When the remote reference obtaining relay object obtains the remote reference of the server object, the skeleton of the server object is instantiated by the ORB in the server computer, and the stub of the server object is instantiated by the ORB in the relay computer. The remote reference relay object holds information for accessing the stub object corresponding to the server object as the remote reference.

(Step 3) Launching the remote method calling relay object

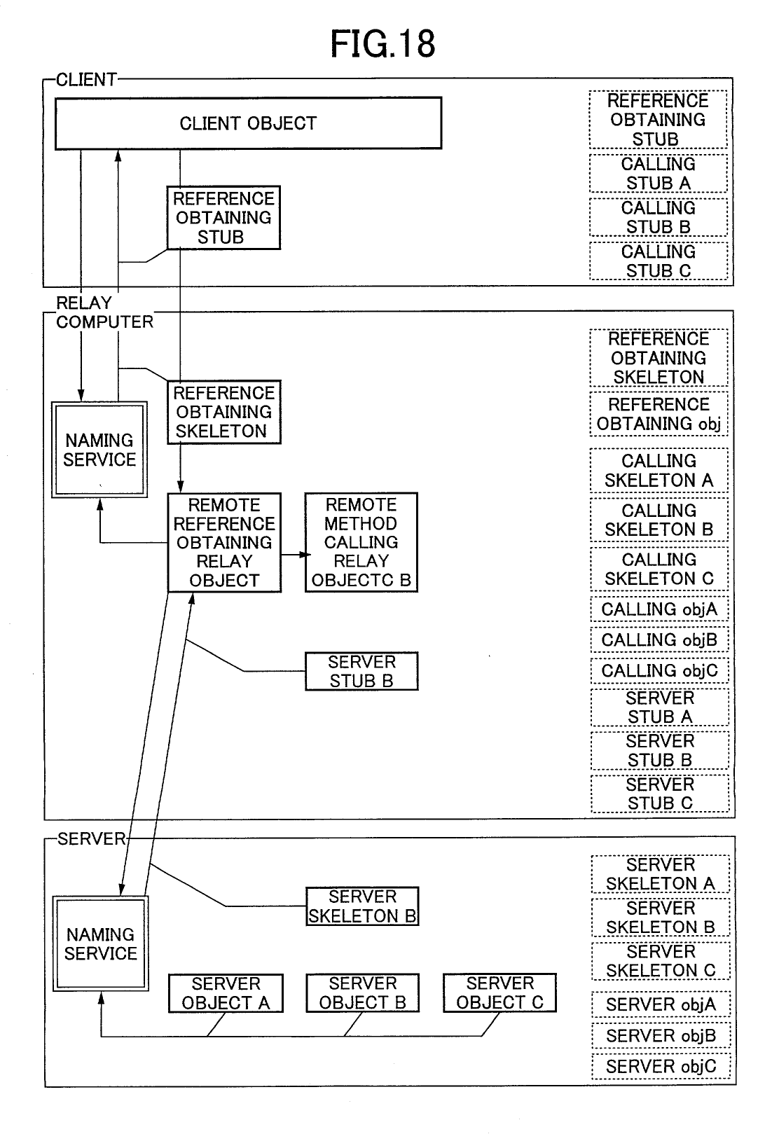

Next, as shown in FIG. 18, the remote reference obtaining relay object in the relay computer identifies and instantiates the remote method calling relay object by checking the remote reference of the server object obtained from the server computer.

(Step 4) Returning remote reference of the remote method calling relay object

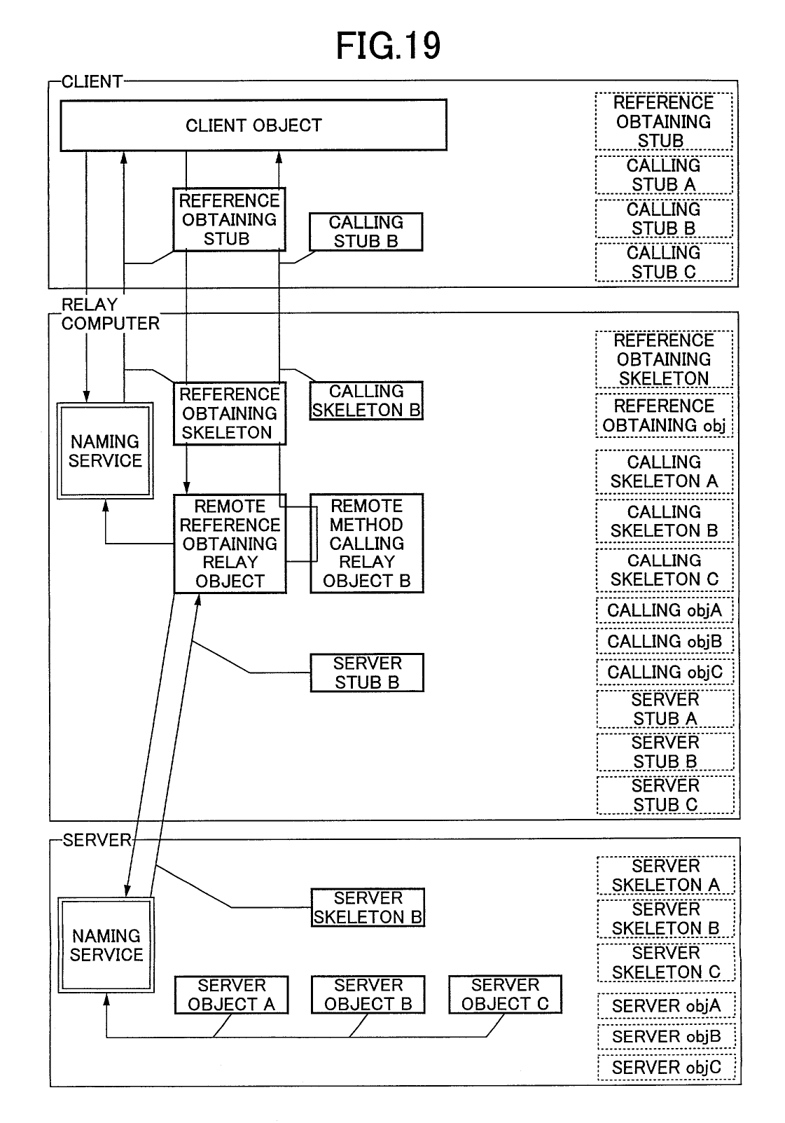

Next, as shown in FIG. 19, the remote reference obtaining relay object returns the remote reference of the instantiated remote method calling relay object to the client object. The remote reference obtaining relay object instantiates the stub of the remote method calling relay object in the relay computer, and instantiates the skeleton of the remote method calling relay object when obtaining the remote reference of the remote method calling relay object.

(Step 5) Method calling of the server object

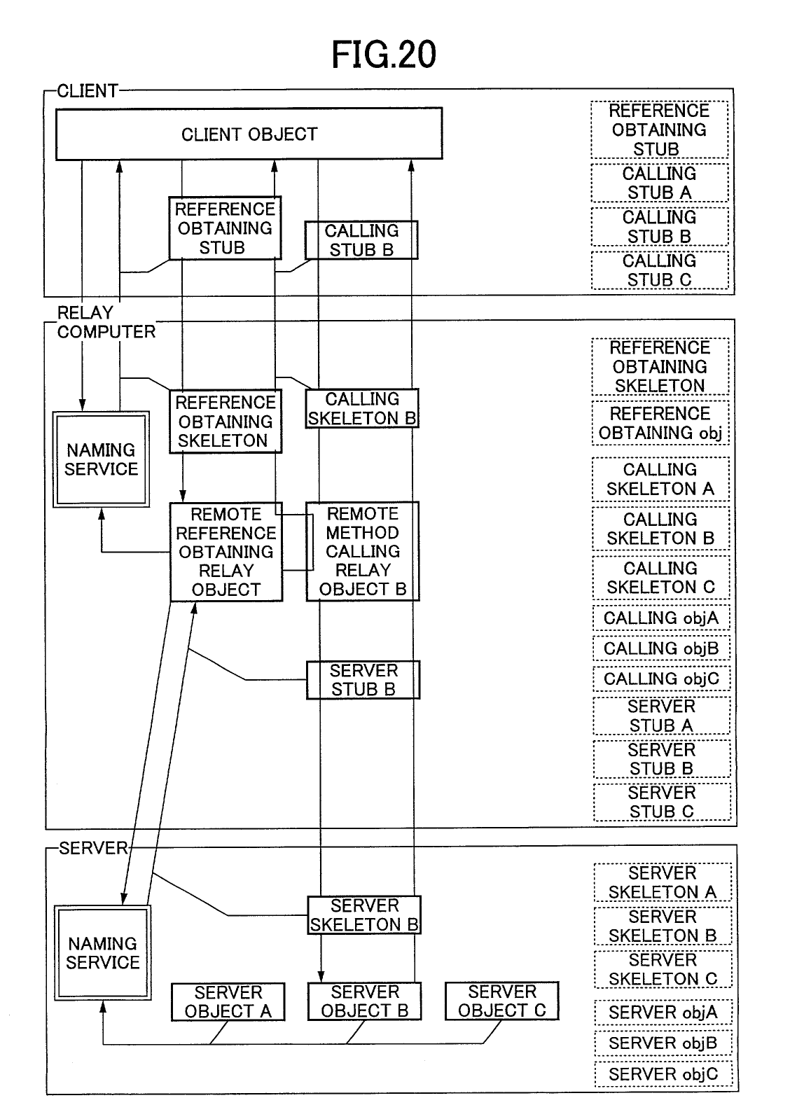

Then, as shown in FIG. 20, the client computer calls a method in the server object B by using the remote method calling relay object, the stub, and the skeleton, which were instantiated in steps 2-4.

(Java program source code examples)

Next, as a more specific example, examples of Java program source code for connecting different ORB products will be shown, in which the client uses a commercially available ORB product (called CLIENT-ORB, for example), and the server uses Java RMI.

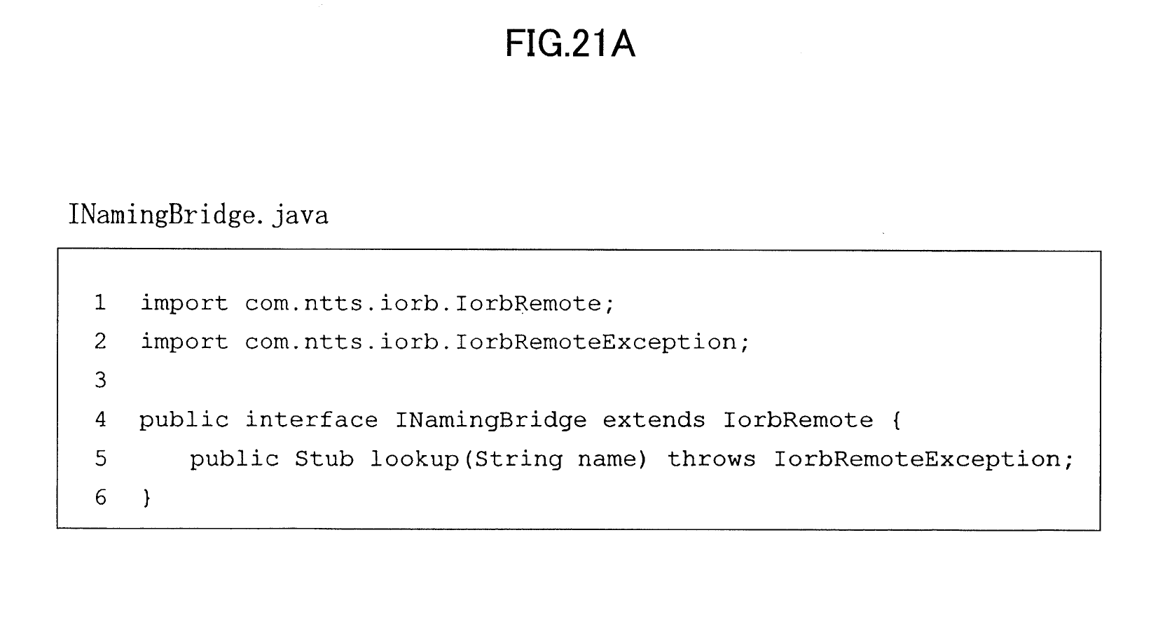

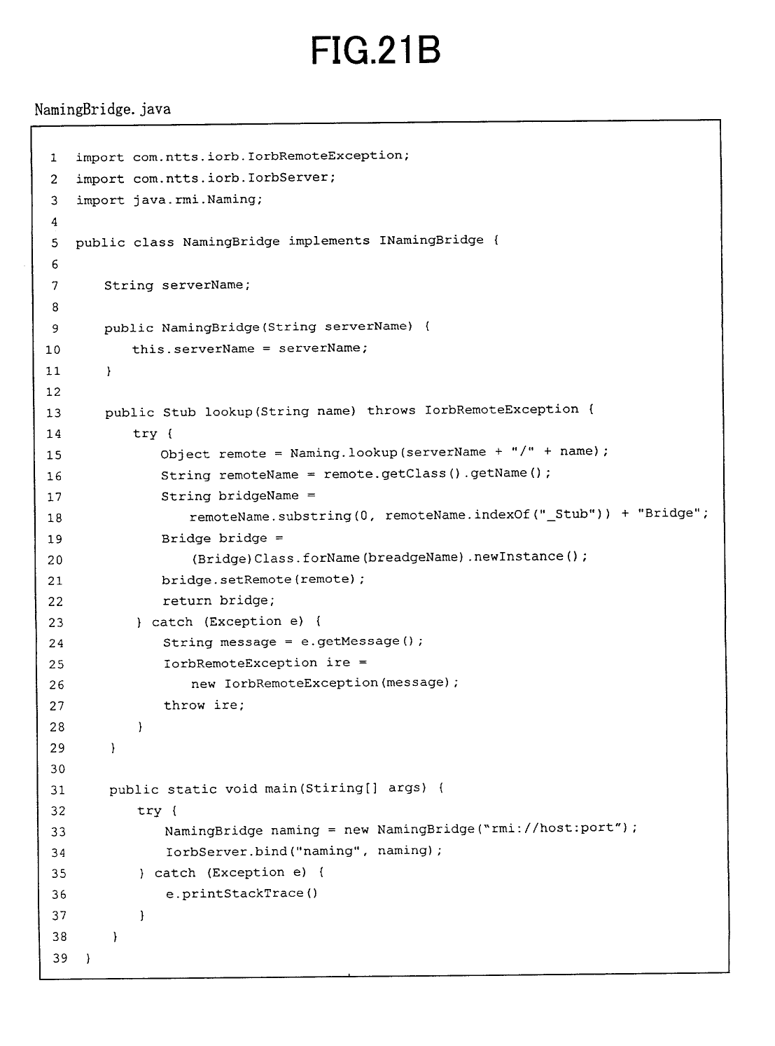

FIG. 21A shows an interface definition example: INamingBridge.java of the remote reference obtaining relay object.

Lines 1-2: Classes to be used are imported.

Line 4: IorbRemote interface provided by CLIENT-ORB is inherited for identifying this interface as a server interface of the CLIENT-ORB.

Line 5: A lookup ( ) method for relaying the remote reference obtaining information is defined. It is defined that IorbRemoteException of the CLIENT-ORB may occur since a remote method is called by using the CLIENT-ORB.

FIG. 21B shows a class definition example: NamingBridge.java of the remote reference obtaining relay object.

Lines 1-3: Classes to be used are imported.

Line 5: The above-mentioned interface is implemented to use as a server class of the CLIENT-ORB.

Lines 7-11: The host name of the server can be set to the argument of the constructor.

Line 13: A lookup ( ) method for relaying remote reference obtaining information is defined. It is defined that IorbRemoteException may occur in the CLIENT-ORB since remote method is called by using the CLIENT-ORB.

Line 15: The remote reference of the corresponding server object is obtained by searching RMI registry (naming service) in the Java RMI by using the name indicated by the argument.

Line 16: The class name of the remote reference is obtained.

Line 17-18: The class name of the remote method calling relay object is constructed from the class name of the remote reference.

Lines 19-20: The remote method calling relay object is instantiated.

Line 21: The remote reference of the server object is set to the remote method calling relay object.

Line 22: The remote reference of the remote method calling relay object is returned to the client.

Lines 23-28: When an exception on Java RMI is caught, it is converted to an exception of the CLIENT-ORB and sent to the client.

Lines 31-38: A main ( ) method is defined for instantiating the remote reference obtaining relay object and registering it as a name of “naming” in the CLIENT-ORB.

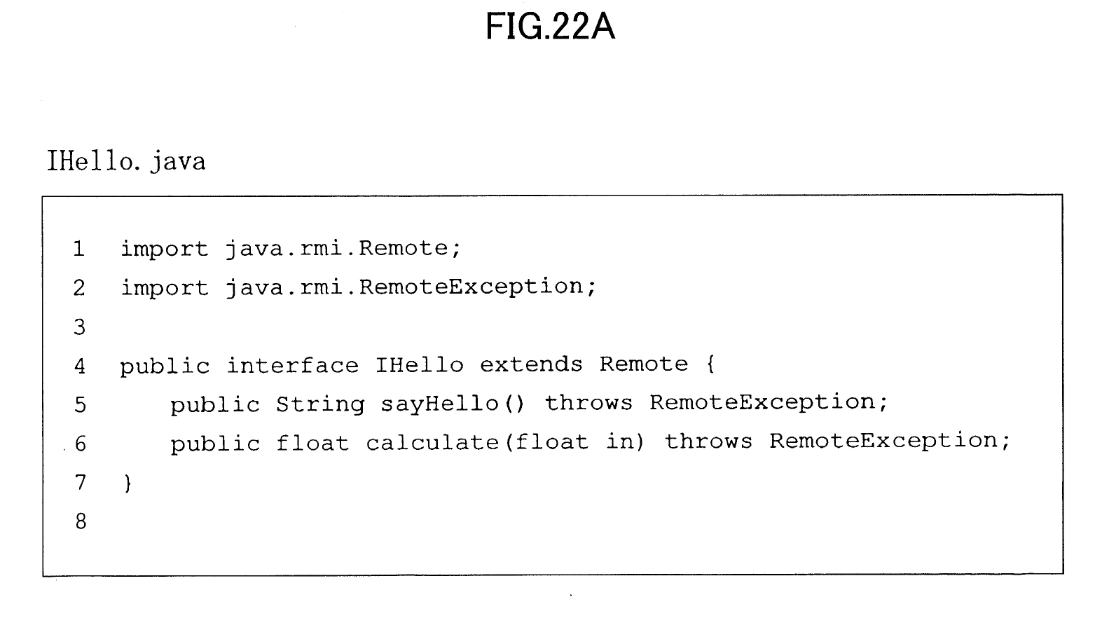

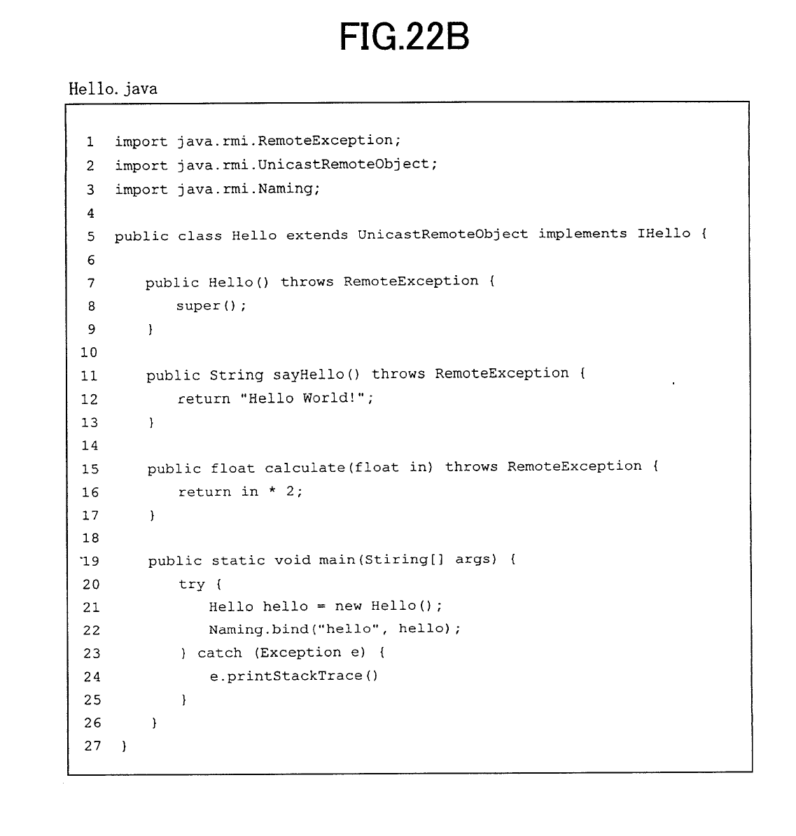

FIG. 22A shows an interface definition example IHello.java of the server object.

Lines 1-2: Classes to be used are imported.

Line 4: Remote interface provided by Java RMI is inherited for identifying this interface as a server interface of the Java RMI.

Lines 5-7: A method to be called from the client is defined. It is defined that RemoteException of the Java RMI may occur since remote method is called by using the Java RMI.

FIG. 22B shows a class definition example: Hello.java of the server object.

Lines 1-3: Classes to be used are imported.

Line 5: UnicastRemoteObject class is inherited for this class to function as a server object of Java RMI.

Lines 7-9: A constructor of a super class is called according to a rule of the Java RMI.

Lines 11-18: A method called from the client is defined. It is defined that RemoteException may occur in the Java RMI since remote method is called by using the Java RMI.

Lines 19-26: A main ( ) method is defined in which the class definition of the server object is instantiated, and is registered in the RMI registry of Java RMI.

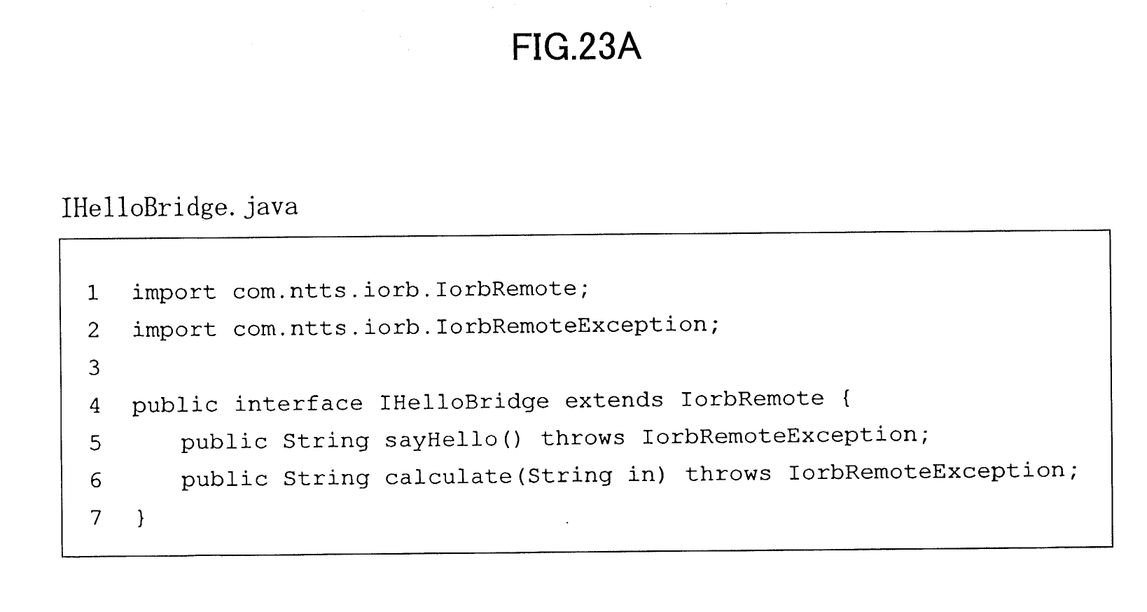

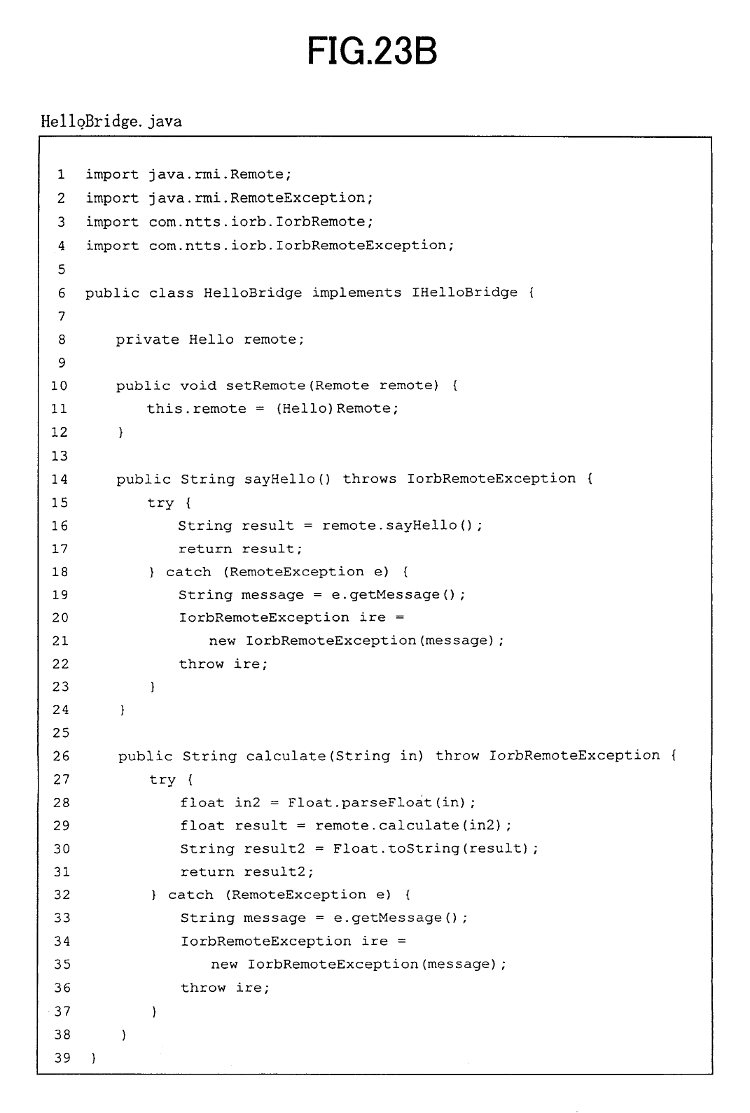

Next, FIG. 23A shows an output example of an interface: IHelloBridge.java of the remote method calling relay object. This interface definition is automatically generated from the above-mentioned server class.

Lines 1-2: Classes to be used are imported.

Line 4: The interface name is constructed from characters of the input class definition of the server object. The construction method in this example is “I”+server class name+“Bridge”. IorbRemote interface provided by CLIENT-ORB is inherited for identifying this interface as a server interface of the CLIENT-ORB.

Lines 5-7: A method the same as the method defined in the input server class is output. If the argument and/or the return value of the method use a type, such as “float” of the calculate ( ) method, which can not be used by the client (J2ME CLDC), the type is replaced with another type that can be used in the client and is interchangeable with “float”. In this example, “float” is replaced with “String”. It is defined that IorbRemoteException may occur in the CLIENT-ORB since remote method is called by using the CLIENT-ORB.

FIG. 23B shows a class output example: HelloBridge.java of the remote method calling relay object. This class definition is also automatically generated from the server class.

Lines 1-4: Classes to be used are imported.

Line 6: The class name is constructed from characters of the input class definition of the server object. The construction method in this example is server class name+“Bridge”. The above-mentioned interface definition of the remote method calling relay object is implemented.

Lines 8-12: A variable for holding the remote reference of the server object and a method for setting the remote reference are output.

Line 14: The same method as the method sayHello ( ) defined in the server class is output. It is defined that IorbRemoteException may occur in the CLIENT-ORB since the method performed remote method calling by using the CLIENT-ORB.

Lines 16-17: The corresponding method sayHello ( ) is called by using the remote reference to the server object. The result of calling is returned to the client.

Line 18-23: If an exception on Java RMI is caught when calling a remote method of the server object, it is converted to IorbRemoteException of the CLIENT-ORB and sent to the client.

Line 26: A method the same as the method calculate ( ) defined in the server class is output. If the argument and/or the return value of the method use a type, such as “float” of the calculate ( ) method, which can not be used by the client (J2ME CLDC), the type is replaced with another type that can be used in the client and is interchangeable with “float”. In this example, “float” is replaced with “String”. It is defined that IorbRemoteException may occur in the CLIENT-ORB since remote method is called by using the CLIENT-ORB.

Line 28: A process for converting the replaced “String” to “float” is defined.

Line 29: The corresponding method calculate ( ) is called by using the remote reference to the server object.

Line 30: A process is defined in which the type of the result of the method calling of the server object is converted from “float” to “String” which is replaced from “float” in the above-mentioned return value definition.

Line 31: The result of conversion is returned to the client.

Line 32-37: If an exception on Java RMI is caught when calling a remote method of the server object, it is converted to IorbRemoteException of the CLIENT-ORB and sent to the client.

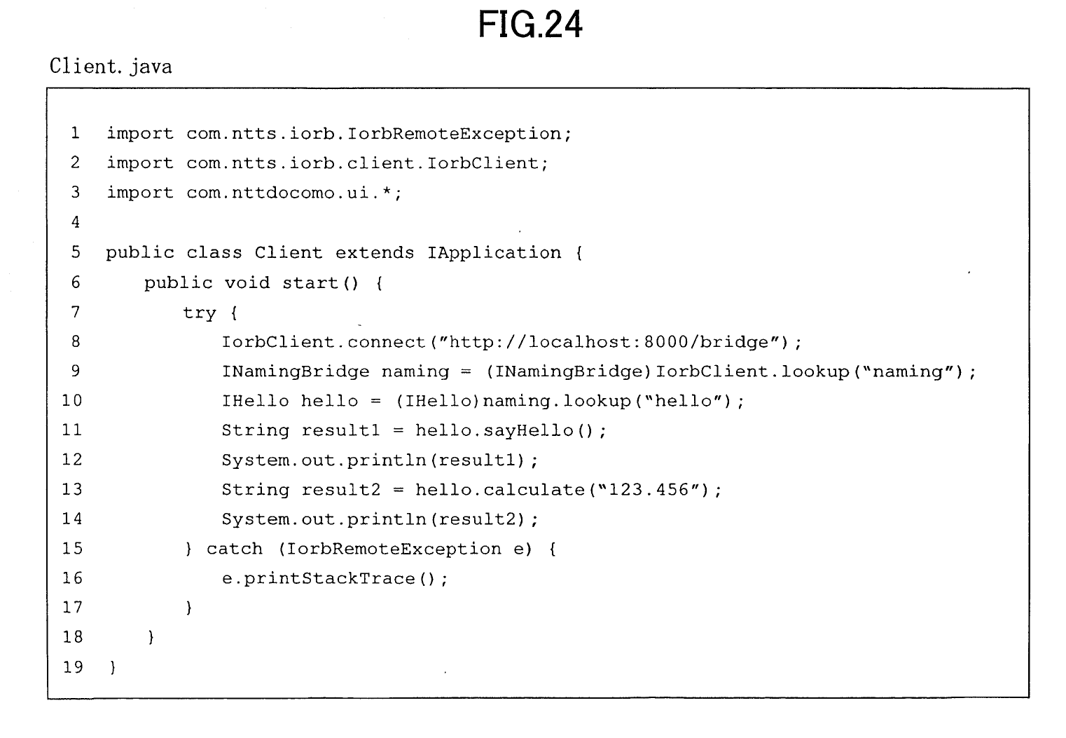

FIG. 24 shows a class definition example: Client.java of the client. In this example, an application in a mobile phone operating in the J2ME CLDC environment calls a function of the server object according to the present invention.

Lines 1-7: Typical parts such as import and class declaration are defined.

Line 8: The client connects to the relay computer.

Line 9: The client obtains the remote reference to the remote reference obtaining relay object which is registered in the CLIENT-ORB by using the name “naming” as a key.

Line 10: The client obtains a remote reference to the remote method calling relay object corresponding to the server object from the remote reference obtaining relay object by using the name “hello” as a key.

Lines 11-12: The client calls the sayHello ( ) method of the server object and the result is output.

Lines 13-14: The client calls the calculate ( ) method of the server object and the result is output.

(Distinctive features of the present invention)

In the following, the distinctive features of the present invention compared with the Japanese laid-open patent application No. 11-282661 will be described.

It is common between the present invention and the technique in the Japanese laid-open patent application No. 11-282661 that server objects to be used are registered beforehand in the naming service in the server and that a relay object is provided between a client and a server. According to the present invention, the remote reference obtaining relay object is registered in the naming service of the relay computer. According to the technique of the Japanese laid-open patent application No. 11-282661, a relay object that realizes a function for obtaining a remote reference for the server object and relaying a method call for the server object is registered.

When accessing a server object, an object in the client obtains, from the naming service in the relay computer, information on the object to be accessed first. At this time, in the present invention, the client obtains information (access information to the remote reference obtaining relay object; corresponding stub object ID) for accessing the remote reference obtaining relay program. On the other hand, according to the Japanese laid-open patent application No. 11-282661, the client obtains access information to the relay object.

Therefore, according to the present invention, only the remote reference obtaining relay object and the corresponding slab/skeleton objects are always activated, and it is unnecessary to always activate the remote method calling relay object and the corresponding stub/skeleton objects. That is, according to the present invention, every time when the client starts to access the server object, the remote reference obtaining relay object instantiates the remote method calling relay object corresponding to the server object (step 409 and step 410 in FIG. 6).

Since the present invention is configured in the above-mentioned way, the remote reference obtaining relay object can be shared for a plurality of server objects, and server objects which can be accessed remotely can be easily added and deleted.

On the other hand, according to the technique of the Japanese laid-open patent application No. 11-282661, it is necessary to always activate the object (relay object) including the remote method calling function. In addition, it is necessary to prepare the relay object for each server object. In addition, according to the technique of the Japanese laid-open patent application No. 11-282661, the size of memory space in the relay server increases in proportion to the number of the server objects to be remotely accessed.

As mentioned above, according to the present invention, when the client and the server use different ORB products in which communication protocols, types of arguments and/or return values of methods are different, the client can connect to the server without a complicated communication protocol conversion program. In addition, by providing a type converting function on the remote method calling relay class, the type of the arguments and/or returned value of methods can be properly converted. Further, as for the problem in that the memory space is uselessly consumed in the relay computer in the technique of the Japanese laid-open patent application No. 11-282661, the present invention solves the problem. That is, according to the present invention, the remote method calling relay object is dynamically instantiated before method calling by the client object, and the remote method calling relay object is deleted after the method calling is performed. Therefore, a new effect that the memory space in the relay computer is not uselessly consumed can be obtained.

The present invention is not limited to the specifically disclosed embodiments, and variations and modifications may be made without departing from the scope of the invention. For example, by using “UDDI service” as the naming service of the ORB (product B) shown in FIG. 6 and by using “Java proxy” as the stub object 260 in the server generated by the ORB (product B) tool, the present invention can be applied to Web services in the same way as embodiments mentioned above.

What is claimed is:

1. A method for performing a method call from an object in a client to an object in a server when a communication protocol of a distributed object middleware in said client and a communication protocol of a distributed object middleware in said server are different, wherein a class of a remote reference obtaining relay object and a class of a remote method calling relay object are provided between said distributed object middleware in said client and said distributed object middleware in said server, said method comprising the steps of:
said remote reference obtaining relay object receiving an obtaining request for a remote reference on said object in said server from said client, and sending said obtaining request to said server;
said remote reference obtaining relay object receiving, from said server, information used for accessing said object in said server, and instantiating said remote method calling relay object corresponding to said object;
said remote reference obtaining relay object sending, to said client, information used for accessing said remote method calling relay object.

2. The method as claimed in claim 1, wherein:
when said remote reference obtaining relay object receives, from said server, information used for accessing said object in said server, a skeleton object corresponding to said object in said server is instantiated in said server, and a stub object corresponding to said object in said server is instantiated in a relay computer that includes said remote reference obtaining relay object;
said skeleton object and said stub object corresponding to said object in said server operate according to a communication protocol of said distributed object middleware in the server;
when said remote reference obtaining relay object sends, to said client, information used for accessing said remote method calling relay object, a skeleton object corresponding to said remote method calling relay object is instantiated in said relay computer, and a stub object corresponding to said remote method calling relay object is instantiated in said client;
said skeleton object and said stub object corresponding to said remote method calling relay object operate according to a communication protocol of said distributed object middleware in said client.

3. The method as claimed in claim 1, said method further comprising the step of:
said remote method calling relay object receiving a remote method call corresponding to a method in said object in said server from said client, and calling said method in said object in said server.

4. The method as claimed in claim 1, wherein said remote method calling relay object includes a function for converting a type of an argument of a method or a type of a return value from a method into a type that can be used in said client.

5. A computer readable medium storing program code for a class of a remote reference obtaining relay object for causing a relay computer to perform remote reference obtaining relay processing for realizing a method call from an object in a client to an object in a server when a communication protocol of a distributed object middleware in said client and a communication protocol of a distributed object middleware in said server are different, wherein said remote reference obtaining relay object and a class of a remote method calling relay object are provided in said relay computer that is provided between said client and said server, said computer readable medium comprising:
program code means for receiving an obtaining request for a remote reference on said object in said server from said client, and sending said obtaining request to said server;
program code means for receiving, from said server, information used for accessing said object in said server, and instantiating said remote method calling relay object corresponding to said object;
program code means for sending, to said client, information used for accessing said remote method calling relay object.
